(19) United States
(12) Patent Application Publication
(10) Pub. No.: US 2012/0039666 A1
(43) Pub. Date: Feb. 16, 2012

(54) CATCH AND MOUNTING APPARATUS FOR THE SAME

(75) Inventors: RI-DONG HUANG, Shenzhen City (CN); CHANG-ZHENG XU, Shenzhen City (CN); DAO-WEI LEI, Shenzhen City (CN); ZHI-CHUN DAI, Shenzhen City (CN); CHIEN-LI TSAI, Tu-Cheng (TW); GUANG-YAO LEE, Tu-Cheng (TW); JEFFREY SHUE JEN LU, Santa Clara, CA (US)

(73) Assignees: HON HAI PRECISION INDUSTRY CO., LTD., Tu-Cheng (TW); HONG FU JIN PRECISION INDUSTRY (ShenZhen) CO., LTD., Shenzhen City, (CN)

(21) Appl. No.: 12/916,614

(22) Filed: Oct. 31, 2010

(30) Foreign Application Priority Data
Aug. 12, 2010 (CN) 201010251821.4

(51) Int. Cl. F16B 21/07

(52) U.S. Cl. 403/326

(57) ABSTRACT

An assembly to mount a catch having a number of claws to an object includes a fixing member extending through the catch to mount the catch to the object, and a limiting member mounted to the fixing member. The limiting member includes a head and a post mounted to the fixing member. The diameter of the head is greater than the distance between every two opposite claws. The head is above the claws, the fixing member, and the post are surrounded by the claws.

### BACKGROUND

1. Technical Field

The disclosure relates to mounting apparatuses for catches, and particularly relates to a mounting apparatus that mounts a catch and protects the catch from interference from an external force.

2. Description of Related Art

Usually, a catch is mounted to an object with a plastic screw. However, installing screws one at a time can be labor consuming and cumbersome. Moreover, during use or assembly, an external force can damage the catch.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of a mounting apparatus for a catch, together with a catch and an object.

FIG. 2 is an assembled, isometric view of the mounting apparatus, the catch, and the object of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

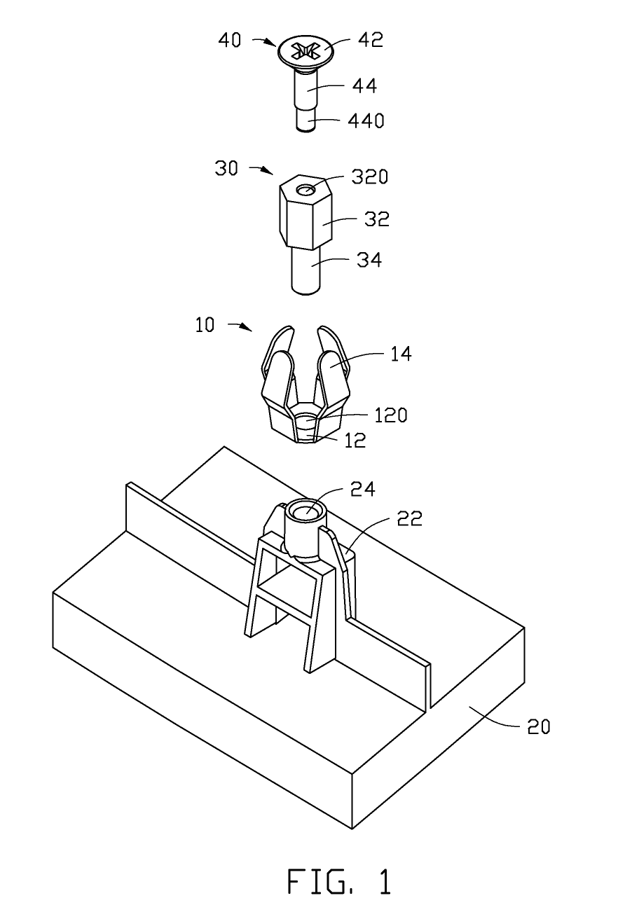

Referring to FIG. 1, a mounting apparatus is provided to mount a catch 10 to an object 20, such as a plate. The mounting apparatus includes a fixing member 30 and a limiting member 40.

The catch 10 includes a base board 12 and a number of V-shaped claws 14 extending from the sides of the base board 12. A through hole 120 is defined in the center of the base board 12. The claws 14 slant and radially extend up from the sides of the base board 12, and then slantingly extend towards the center of the base board 12.

The object 20 includes a protrusion 22, the protrusion 22 defines a mounting hole 24.

The fixing member 30 includes a connection portion 32 and a fixing portion 34 extending from a bottom of the connection portion 32. The size of the cross-section of the connection portion 32 is greater than the size of the cross-section of the fixing portion 34. The connection portion 32 defines an engaging hole 320.

The limiting member 40 includes a head 42 and a post 44 extending from the head 42. A fixing end 440 extends from a distal end of the post 44 away from the head 42. The diameter of the head 42 is larger than the distance between every two opposite claws 14.

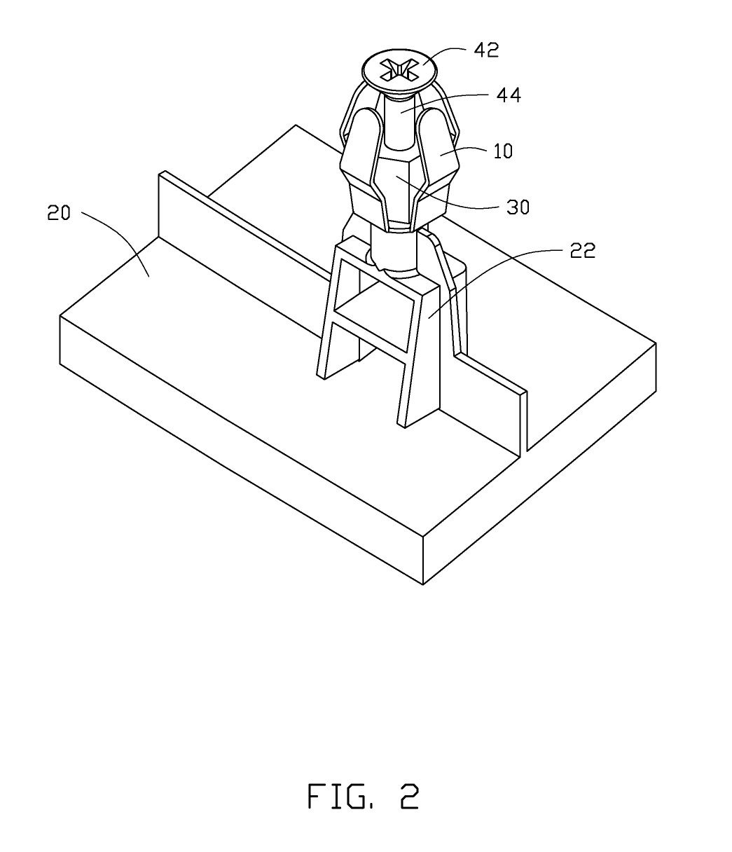

Referring to FIG. 2, in assembly, the fixing end 440 of the limiting member 40 is engaged in the engaging hole 320 of the fixing member 30. The fixing portion 34 of the fixing member 30 is extended through the through hole 120 of the catch 10, and then engaged in the mounting hole 24 of the object 20. The bottom of the connection portion 32 of the fixing member 30 resists against the base board 12, to press the catch 10 to the object 20. In this state, the claws 14 of the catch 10 surround the post 44 of the limiting member 40 and the connection portion 32. Therefore, when the claws 14 are forced to deform towards the post 44, the post 44 and the connection portion 32 resist against the claws 14, to prevent the claws 14 from deforming further, and assure the deformation of the claws 14 within an allowed range. In addition, there is no space to urge the claws 14 to be deformed away from the post 44 because of the distal ends of the claws 14 are located under the head 42 of the limiting member 40, so that the claws 14 are protected from interference of external forces.

It is believed that the present embodiment and its advantages will be understood from the foregoing description, and it will be apparent that various changes may be made thereto without departing from the spirit and scope of the description or sacrificing all of their material advantages, the example hereinbefore described merely being exemplary embodiment.

What is claimed is:

1. A mounting apparatus provided to mount a catch having a plurality of claws to an object, the mounting apparatus comprising:
a fixing member located among the plurality of claws and extending through the catch to fix the catch to the object; and
a limiting member mounted to the fixing member, the limiting member comprising a head and a post mounted to the fixing member, the diameter of the head being larger than a distance between every two opposite claws;
wherein the head is above the plurality of claws, and the plurality of claws surrounds the fixing member and the post.

2. The mounting apparatus of claim 1, wherein the fixing member comprises a connection portion defining an engaging hole, the post extends from the head of the limiting member, and a fixing end extends from a distal end of the post opposite to the head to engage in the engaging hole.

3. The mounting apparatus of claim 2, wherein the fixing member further comprises a fixing portion extending from the connection portion, the fixing portion extends through the catch, and then fixed to the object.

4. An assembly comprising:
a catch comprising a plurality of claws;
a fixing member extending through the catch to engage with an object, thereby to mount the catch to the object; and
a limiting member mounted to the fixing member, the limiting member comprising a head and a post mounted to the fixing member, the diameter of the head being larger than a distance between every two opposite claws;
wherein the head is above the plurality of claws, and the plurality of claws surround the fixing member and the post.

5. The assembly of claim 4, wherein the fixing member comprises a connection portion defining an engaging hole, the post extends from the head of the limiting member, and a fixing end extends from a distal end of the post opposite to the head to engage in the engaging hole.

6. The assembly of claim 5, wherein the fixing member further comprises a fixing portion extending from a bottom of the connection portion, the fixing portion extends through the catch, and then is engaged with the object.

7. The assembly of claim 6, wherein the catch comprises a base board defining a through hole, the fixing portion is extended through the through hole.

8. The assembly of claim 7, wherein the bottom of the connection portion of the fixing member resists against the base board.

9. The assembly of claim 4, wherein the catch comprises a base board defining a through hole, the fixing member is extended through the through hole to engage in the object.

10. The assembly of claim 9, wherein each claw slantingly and radially extends up from sides of the base board, and then slantingly extends towards the center of the base board.

11. The assembly of claim 9, wherein the fixing member comprises a connection portion defining an engaging hole, the post extends from the head of the limiting member, and a fixing end extends from a distal end of the post to engage in the engaging hole.
